(19) United States
(12) Patent Application Publication
(10) Pub. No.: US 2007/0038579 A1
(43) Pub. Date: Feb. 15, 2007

(54) System and method using order preserving hash

(75) Inventor: Carl Ansley, New York, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TSYS-Prepaid, Inc.

(21) Appl. No.: 11/202,471

(22) Filed: Aug. 12, 2005

(51) Int. Cl. G06Q 99/00

(52) U.S. Cl. 705/64

(57) ABSTRACT

A computer implemented system and method for creating and using an order preserving hash function are provided. In an illustrative implementation, a computing environment comprises a data store having data stored in a selected order (e.g., ascending alphabetical listing) and one more instructions sets providing instructions to the computing environment to process the data found in the data store according to a selected order preserving hash. The order preserving hash can comprise one or more instructions to process data such that native data stored in the data store can act as input to an order preserving hash algorithm to produce encoded output data. The encoded output data can comprise a numerical index that is representative of the selected order (e.g., ascending alphabetical listing). In the illustrative implementation, the order-preserving hash algorithm can utilize one or more arithmetic coding schemes to encode the native data and to generate the numerical index.

### FIELD OF INVENTION

The present invention relates to data processing and, more particularly, to data processing systems and methods that utilize order preserving hash operations.

### BACKGROUND

Data security is critical when performing electronic data storage and/or electronic data exchange. Given the ubiquitous nature of electronic data, data security is tantamount to reliable data communications and data storage. From simple password security measures to extremely sophisticated data encryption, numerous data security measures (e.g., both software and hardware) have been developed to ensure that data is stored and/or communicated in a secure manner. These solutions are generally deployed in many data processing systems and applications that include bank transactions (online or otherwise), payment transactions, enterprise computing (e.g., remote access to enterprise data), telecommunications (e.g., mobile computing and telephony), and software distribution (e.g., downloading software online).

Depending on the nature of the data, one or more data security measures can be implemented to safeguard the electronic data. The data security measures can be software based, hardware based or a combination of both. Current practices can operate to secure electronic data by offering security measures for the electronic data itself (e.g., encryption) and/or by providing security measures for the computing environment(s) in which the electronic data is being exchanged and/or stored. Hardware and/or environment security measures typically operate to provide one or more physical and/or electronic measures to secure data in the environment. Such measures can include user authentication (e.g., user id and password) prior to allowing access to the environment, physical keys on computer hardware, and biometric security devices (e.g., fingerprint scan, retinal scan, and voice recognition scans).

Security measures operating on the electronic data generally operate to manipulate the data to have a different format than the original data format such as data encryption. The electronic data having the new format can then be restored to its original data format through a separate process such as decryption. Numerous encryption and decryption techniques and operations have been developed and are used to ensure data security. A limitation, however, to encryption and decryption techniques includes the inability of computing environments to search encrypted data in a data store. Conventional data stores, although capable of storing encrypted data, can not operate efficiently to search upon encrypted data. In the context of searching for desired data items encrypted and stored in a data store, each data item stored in the data store in encrypted form would first have to be decrypted and then searched to identify desired data items. Such practice is impractical and extremely inefficient when searching data stores having hundreds, thousands, or millions of data items. In such context, a simple search could result in significant wait times and, more importantly, use of valuable data processing resources.

From the foregoing it is appreciated that there exists a need for system and methods that overcome the shortcomings of existing practices.

### SUMMARY

A computer implemented system and method for creating and using an order preserving hash function are provided. In an illustrative implementation, a computing environment comprises a data store having data stored in a selected order (e.g., ascending alphabetical listing) and one more instructions sets providing instructions to the computing environment to process the data found in the data store according to a selected order preserving hash. In the illustrative implementation, the order preserving hash can comprise one or more instructions to process data such that native data stored in the data store can act as input to an order preserving hash algorithm to produce encoded output data representative of the hash algorithm that is applied. In the illustrative implementation, the encoded data can comprise a numerical index that is representative of the selected order (e.g., ascending alphabetical listing). In the illustrative implementation, the order-preserving hash algorithm can utilize one or more arithmetic coding methods to encode the native data and to generate the numerical index.

In an illustrative operation, the generated numerical index along with the encrypted data can be stored in the exemplary data store. In this illustrative operation, the generated numerical index can be used as a reference to select data for retrieval from the data store. When retrieved, data, that is stored in a selected order in the data store, is associated by the exemplary computing environment within a particular range in the generated numerical index and retrieved on that basis.

Other features of the herein described systems and methods are further described below.

### BRIEF DESCRIPTION OF THE DRAWINGS

The order preserving hash system and methods are further described with reference to the accompanying drawings in which:

FIG. 1 is a block diagram of an exemplary computing environment in accordance with an implementation of the herein described systems and methods;

FIG. 2 is a block diagram of an exemplary networked computing environment;

FIG. 3 is a block diagram of an illustrative order-preserving has computing environment in accordance with the herein described systems and methods;

FIG. 4 is a block diagram of another illustrative data processing environment in accordance with the herein described systems and methods;

FIG. 5 is a block diagram showing the application of an order-preserving hash function on exemplary data in accordance with the herein described systems and methods;

FIG. 6 is a flow diagram showing the processing performed when applying an order-preserving hash function on exemplary data in accordance with the herein described systems and methods; and

FIG. 7 is a flow diagram showing the processing performed when retrieving processed data from a data store using an order-preserving hash function in accordance with the herein described systems and methods.

### DETAILED DESCRIPTION

Overview:

Information security is becoming critical to the reliability and credibility of electronic transaction services. The proliferation of the Internet has allowed for the deployment of numerous transaction services (e.g., e-commerce websites) that avail participating users the ability to transact for goods and services. As more competing transaction services (e.g., PAYPAL, merchant accounts, credit card authorization, pre-paid debit cards, electronic gift certificates, reward cards, etc.) are deployed, participating users can use reliability and security of information as a discriminating factor when choosing to engage one transaction service over another. Often such transaction services (and websites that use such transaction services) will require the participating user to establish an electronic account that contains sensitive and private information about a participating user. User information can include but is not limited to the participating user's billing address (which is often the participating user's home address), billing account information (e.g., bank account, credit card number, debit card number, pre-paid debit card number, electronic gift certificate, reward card number, etc.), and user preferences for particular products and/or services. It is appreciated that participating users would seek transaction service providers that would have policies and procedures in place to ensure that such information is kept confidential and is secure from third party attack (e.g., hackers wishing to compromise user data).

Current practices provide security to information but are generally limited to securing the communication of information between a participating user and a transaction service provider. In this context there are various encryption/decryption type schemes (e.g., Secure Sockets Layer (SSL), PGP, and PKI) that are deployed to ensure that the communication of sensitive and private information is realized over a secure and encrypted communication path. Once delivered to the transaction services provider, the transaction services provider generally stores such sensitive and private information in conventional data stores on their internal computing environment. The transaction service providers often take the necessary steps to employ additional information security measures (e.g., firewalls, proxy servers, etc—both in software and hardware deployments) that attempt to prevent electronic access to transaction service provider's internal computing environment.

However, current practices generally do not address securing the participating user's data once it has been stored in the data store resident on the transaction service provider's internal computing environment. Although there are practices that allow for the encryption and decryption of data in data stores, such practices are generally very ineffective, cumbersome, and resource intensive (e.g., requires significant processing resources). Data store computing applications generally are not designed to store, index, and retrieve encrypted data. Current encryption schemes can operate to generate a randomized 128 (or 256) bit numerical representation for a given piece of data. The representation can be generated using a encryption key which also can then be used to decrypt the numerical representation to retrieve the original piece of data. As such what might be a 20 bit original piece of data, would be stored as a 128 (or 256) bit encrypted data in a data store.

As such, if encrypted data is stored in a data store, the entire data store would have to be decrypted according to the selected encryption scheme to identify the piece of data that is desired to be retrieved. Since the encrypted data has a randomized numerical representation and such representation is not ordered, each stored encrypted item would require decryption to identify the desired piece of original data. It is appreciated that such processing is extremely inefficient and resource intensive when considering that the data store could be required to process thousands of requests to retrieve original data within a given time period.

The herein described systems and methods ameliorate the shortcomings of existing practices and conventions by providing an order preserving hash application that allows for the efficient storage and retrieval of encoded data. In an illustrative implementation a order preserving hash application operating in an exemplary computing environment and operating on data that can be ordered is provided. In an illustrative operation, a set of original data that can be ordered by one or more elements in the original data (e.g., a set of user account data that can be ordered by the user's last name) can act as input to the order-preserving hash application. In the illustrative operation, the order-preserving hash computing application can operate to encode the original data using one or more arithmetic coding schemes.

In this context, the hash computing application can operate to set an interval (e.g., 0-1) for the numerical index that is created for the data being encoded. The interval is then associated with a selected model which can provide instructions to associate a probability what the next character in the data stream. This probability is reflected as a number in the chosen interval (e.g., the probability that “A” will be followed by another “A” is 0.57864340). Furthermore, the hash computing application can operate to sub-divide additional intervals along the data (e.g., message) so more accuracy can be obtained in the model and with the probabilities. The order preserving hash algorithm can further operate to assign ascending fractions to ascending ordered data such that data starting with a “Z” might have a fractional representation closer to 1 than 0 (e.g., 96754671).

In the illustrative operation, after the ordered data is encoded and a numerical representation of the encoded data is stored in a cooperating data store in the exemplary computing environment. When the data is desired to be retrieved, the query for data (e.g., retrieve all user profiles for users with the last name “Smith”) is processed by the hash computing application to generate the numerical representation for “Smith”. The numerical representation can then be compared with the generated numerical index for the data store to retrieve data having “Smith” in it. Additionally, the data store can operate such that data associated with “Smith” be provided the same numerical representation to allow for the look up and retrieval of entire records and not just individual pieces of data. As such, the data store can operate to store encoded data (e.g., as numerical representations) exclusively and as such can provide an additional level of security to private and confidential information that is not afforded by current practices and applications.

The herein described systems and methods can operate efficiently since one-way encoded is being performed both in the encoding of the data and in the look up to retrieve data. With one-way encoding (i.e., hash algorithm operating to only produce one output which is then compared against previously produced outputs), fewer errors can be realized and increase in reliability can be achieved.

Illustrative Computing Environment

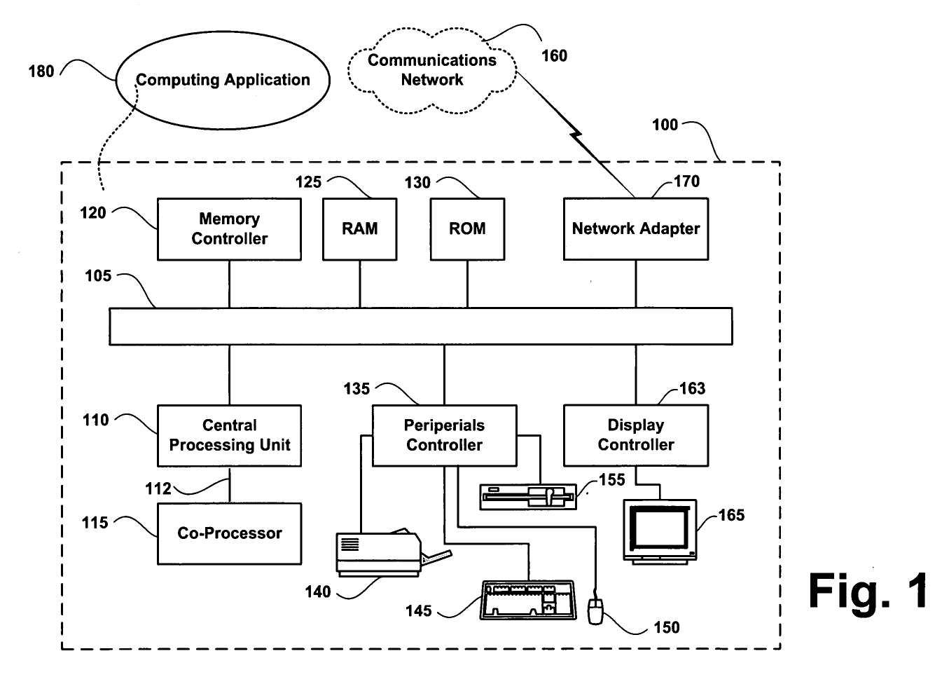

FIG. 1 depicts an exemplary computing system 100 in accordance with herein described system and methods. Computing system 100 is capable of executing a variety of computing applications 180. Exemplary computing system 100 is controlled primarily by computer readable instructions, which may be in the form of software, where and how such software is stored or accessed. Such software may be executed within central processing unit (CPU) 110 to cause data processing system 100 to do work. In many known computer servers, workstations and personal computers central processing unit 110 is implemented by micro-electronic chips CPUs called microprocessors. Coprocessor 115 is an optional processor, distinct from main CPU 110, that performs additional functions or assists CPU 110. CPU 110 may be connected to co-processor 115 through interconnect 112. One common type of coprocessor is the floating-point coprocessor, also called a numeric or math coprocessor, which is designed to perform numeric calculations faster and better than general-purpose CPU 110.

It is appreciated that although an illustrative computing environment is shown to comprise a single CPU 110 that such description is merely illustrative as computing environment 100 may comprise a number of CPUs 110. Additionally computing environment 100 may exploit the resources of remote CPUs (not shown) through communications network 160 or some other data communications means (not shown).

In operation, CPU 110 fetches, decodes, and executes instructions, and transfers information to and from other resources via the computer's main data-transfer path, system bus 105. Such a system bus connects the components in computing system 100 and defines the medium for data exchange. System bus 105 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 110. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process's virtual address space unless memory sharing between the processes has been set up.

In addition, computing system 100 may contain peripherals controller 135 responsible for communicating instructions from CPU 110 to peripherals, such as, printer 140, keyboard 145, mouse 150, and data storage drive 155.

Display 165, which is controlled by display controller 163, is used to display visual output generated by computing system 100. Such visual output may include text, graphics, animated graphics, and video. Display 165 may be implemented with a CRT-based video display, an LCD-based flat-panel display, gas plasma-based flat-panel display, a touch-panel, or other display forms. Display controller 163 includes electronic components required to generate a video signal that is sent to display 165.

Further, computing system 100 may contain network adaptor 170 which may be used to connect computing system 100 to an external communication network 160. Communications network 160 may provide computer users with means of communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that exemplary computer system 100 is merely illustrative of a computing environment in which the herein described systems and methods may operate and does not limit the implementation of the herein described systems and methods in computing environments having differing components and configurations as the inventive concepts described herein may be implemented in various computing environments having various components and configurations.

Illustrative Networked Computing Environment:

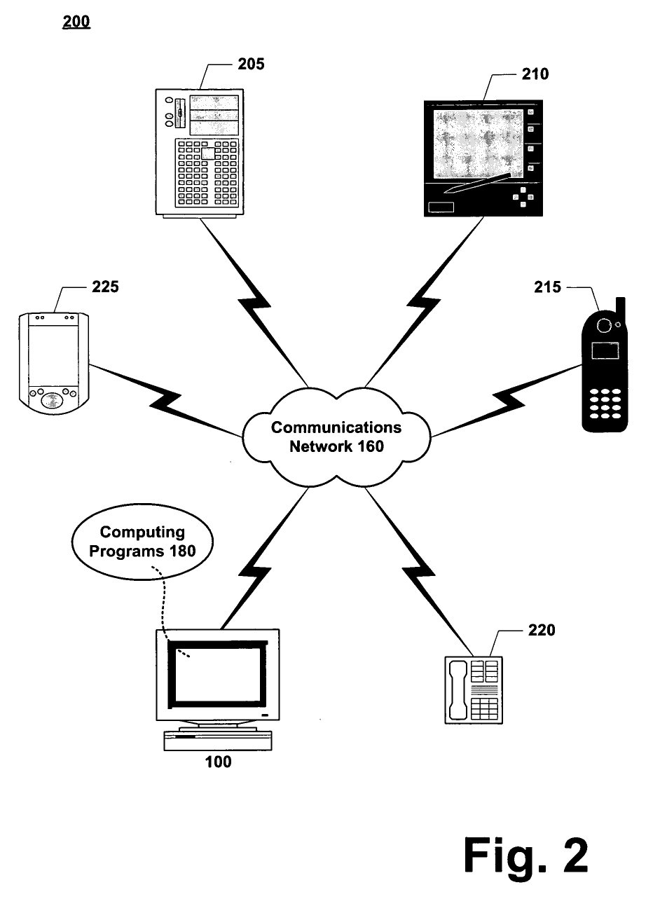

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2 server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication of web services and may cooperate with other server computing environments (not shown), third party service providers (not shown), network attached storage (NAS) and storage area networks (SAN) to realize such web services transactions.

Thus, the systems and methods described herein can be utilized in a computer network environment having client computing environments for accessing and interacting with the network and server computing environments for interacting with client computing environment. However, the apparatus and methods providing the order preserving hash computing environment architecture can be implemented with a variety of network-based architectures, and thus should not be limited to the example shown. The herein described systems and methods will now be described in more detail with reference to a presently illustrative implementation.

Arithmetic Coding:

Arithmetic coders produce near-optimal output for a given set of symbols and probabilities. Compression algorithms that use arithmetic coding can start by determining a model of the data (e.g., a prediction of what patterns will be found in the symbols of a given piece of data). In practice, the more accurate the prediction, the closer to optimality the output will be. For example, a simple static model for describing the output of a particular monitoring instrument over time can have the following output outcomes and probabilities: 60% chance of symbol “NEUTRAL”; 20% chance of symbol “POSITIVE”; 10% chance of symbol “NEGATIVE”; and 10% chance of symbol “END-OF-DATA”.

In practice, models can handle a variety of alphabets other than the simple four-symbol provided in the above example. Additionally, more sophisticated models can also be implemented. For example, higher-order modeling can operate to change the estimation of the current probability of a symbol based on the symbols that precede it (e.g., the context), so that in a model for English text, for example, the percentage chance of “u” could be much higher when it followed a “Q” or a “q”. Also, models can operate to be adaptive, so that they continuously change their prediction of the data based on what the stream actually contains.

When encoding data, each step of the encoding process, except for the very last, is the same; the encoder has basically just three pieces of data to consider. These pieces of data include: 1) the next symbol that needs to be encoded, 2) the current interval, and 3) the probabilities the model assigns to each of the various symbols that are possible at a given step (higher-order and adaptive models can operate on a process such that the probabilities are not the same in each step of encoding). Furthermore, the encoder can operate to divide the current interval into sub-intervals, each representing a fraction of the current interval proportional to the probability of that symbol in the current context. Whichever interval corresponds to the actual symbol that is next to be encoded becomes the interval used in the next step.

For example, in the example provided above (e.g., four-symbol model), the interval for “NEUTRAL” can be [0,0.6), the interval for “POSITIVE” could be [0.6,0.8), the interval for “NEGATIVE” could be [0.8, 0.9), and the interval for “END-OF-DATA” could be [0.9, 1.0). When all symbols have been encoded, the resulting interval identifies, unambiguously, the sequence of symbols that produced it. The symbol sequence can hence be reconstructed if the final interval and model used are known. In practice, it might not be necessary to transmit the final interval, rather, encoding and decoding can be accomplished if one fraction that lies within that interval is known. When communicating this data for subsequent decoding, enough digits (in whatever base) might be transmitted of the fraction so that all fractions that begin with those digits fall into the final interval. In doing so, more data can be communicated across the same communications path using less information.

For example, a message encoded with the four-symbol model above can be decoded using the following steps. First, the message can be encoded in the fraction 0.538. Using the model described above (e.g., having the interval [0,1)) the interval can be divided into the same four sub-intervals that the encoder employed. The communicated fraction 0.538 falls into the sub-interval for “NEUTRAL,” [0, 0.6); this indicates that the first symbol the encoder read must have been “NEUTRAL,” so the first symbol of the message is known to be “NEUTRAL”. The interval [0, 0.6) can then be divided into sub-intervals such that the interval for “NEUTRAL” can be [0, 0.36)—60% of [0, 0.6), the interval for “POSITIVE” can be [0.36, 0.48)—20% of [0, 0.6) the interval for “NEGATIVE” can be [0.48, 0.54)—10% of [0, 0.6), and the interval for “END-OF-DATA” cab be [0.54, 0.6).—10% of [0, 0.6). Our fraction of 0.538 is within the interval [0.48, 0.54), therefore the second symbol of the message must have been “NEGATIVE”.

The current interval can then be further divided into sub-intervals such that the interval for “NEUTRAL” would be [0.48, 0.516), the interval for “POSITIVE” would be [0.516, 0.528), the interval for “NEGATIVE” would be [0.528, 0.534), the interval for “END-OF-DATA” would be [0.534, 0.540). The communicated fraction of 0.538 falls within the interval of the END-OF-DATA symbol and therefore it must be the next symbol in the message. Since it is also the internal termination symbol, it also means that decoding is completed.

The same message could have been encoded by the equally short fractions 0.534, 0.535, 0.536, 0.537 or 0.539 that suggests that the use of decimal instead of binary introduces some inefficiency. In comparison with a binary representation of the fraction, the information content of a three-digit decimal is approximately 9.966 bits. Hence, the same message could have been encoded in the binary fraction 0.10001010 (equivalent to 0.5390625 decimal) at a cost of 8 bits. This is only slightly larger than the information content, or entropy of the message, which with a probability of 0.6% has an entropy of approximately 7.381 bits. It is also appreciated that in this example, the final zero should be specified in the binary fraction, otherwise the message would be ambiguous.

The above explanations of arithmetic coding contain some simplification. In particular, they are written as if the encoder first calculated the fractions representing the endpoints of the interval in full, using infinite precision and only converted the fraction to its final form at the end of encoding. Rather than try to simulate infinite precision, most arithmetic coders instead can operate at a fixed limit of precision and round the calculated fractions to their nearest equivalents at that precision.

For example, if the model called for the interval [0,1) to be divided into thirds, and this was approximated with 8 bit precision then the fractions representing the intervals can be expressed as follows:

| | | Interval | Interval | |
|---|---|---|---|---|
| | | reduced to | reduced to | |
| | Probability | eight-bit | eight-bit | |
| | (expressed as | precision | precision | Range in |
| Symbol | fraction) | (as fractions) | (in binary) | binary |
| A | ⅓ | [0, 85/256) | [0.00000000, | 00000000- |
| | | | 0.01010101) | 01010100 |
| B | ⅓ | [ 85/256, 171/256) | [0.01010101, | 01010101- |
| | | | 0.10101011) | 10101010 |
| C | ⅓ | [ 171/256, 1) | [0.10101011, | 10101011- |
| | | | 1.00000000) | 11111111 |

A process called renormalization can be deployed to keep the finite precision from becoming a limit on the total number of symbols that can be encoded. Whenever the range is reduced to the point where all values in the range share certain beginning digits, those digits can then be sent to the output. However many digits of precision the computer can handle, it is now handling fewer than that, so the existing digits are shifted left, and at the right, new digits are added to expand the range as widely as possible. Hence with renormalization the previously described example can be represented as:

| | | | Digits that | |
|---|---|---|---|---|
| | | | can be sent | Range after |
| Symbol | Probability | Range | to output | renormalization |
| A | ⅓ | 00000000- | 0 | 00000000- |
| | | 01010100 | | 10101001 |
| B | ⅓ | 01010101- | None | 01010101- |
| | | 10101010 | | 10101010 |
| C | ⅓ | 10101011- | 1 | 01010110- |
| | | 11111111 | | 11111111 |

Transaction Payment Processing:

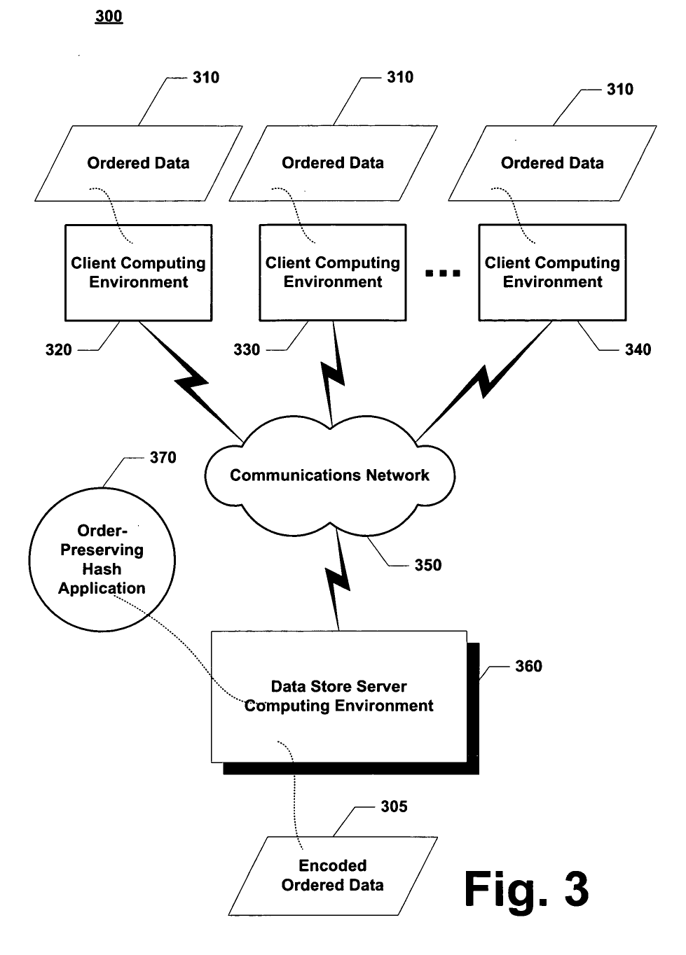

FIG. 3 is a block diagram of an illustrative order-preserving hash computing environment (that can be used as part of a transaction payment processing environment). As is shown in FIG. 3, exemplary order-preserving hash computing environment 300 comprises a plurality of client computing environments, client 320, client 330, up to and including client 340 each operable to process and display ordered data 310. Additionally, exemplary order-preserving hash computing environment 300 further comprises communications network 350 and server 360 operating order-preserving hash application 370 operable to process encoded ordered data 305. Order-preserving hash application 370 can comprise one or more arithmetic coding schemes and instructions sets.

In operation, one or more of the plurality of clients (client 320, client 330, up to client 340 respectively) can request from or send to server 360 encoded ordered data 305 over communications network 350. In the instance data is being requested from server 360, a request is provided by one or more of client 320, client 330, up to client 340 over communications network 350 to server 360. Order-preserving hash application 370 can process the request for information and can cooperate with server 360 to retrieve one or more portions of encoded ordered data 305. In turn, one or more portions of encoded ordered data 305 can be processed by order-preserving hash application 370 to generate responsive data to satisfy the request for data by the one or more clients (client 320, client 330, up to client 340). The responsive ordered data 310 is then communicated to the requesting client(s) (client 320, client 330, up to client 340) over communications network 350. The responsive ordered data 310 can then be processed for display and navigation (or for further processing) by client 320, client 330, up to client 340 as ordered data 310.

In an illustrative implementation, client 320 can represent a customer service representative, communications network 350 can represent an internal communications network (or the Internet), and order-preserving hash application can represent a computing application employing one or more arithmetic coding schemes. In operation, a customer service representative (e.g., client 320) can request the order-preserving hash computing 370 to retrieve one or more portions of encoded ordered data 310. In this context, client 320 can send a request to retrieve one or more portions of encoded ordered data 310 to order-preserving hash application 370 over communications network 350. Order-preserving hash application 370 can operate to process the request for retrieval of encoded ordered data 310 and cooperate with the server 360 to retrieve encoded ordered data (e.g., user account data, transaction card data, etc.) 310 for use by client 320.

It is appreciated that although an illustrative order-preserving hash computing environment is described to have various components cooperating in various configurations that such description is merely exemplary as the inventive concepts described herein can be applied to a number of order-preserving hash computing environments having different components cooperating in different configurations.

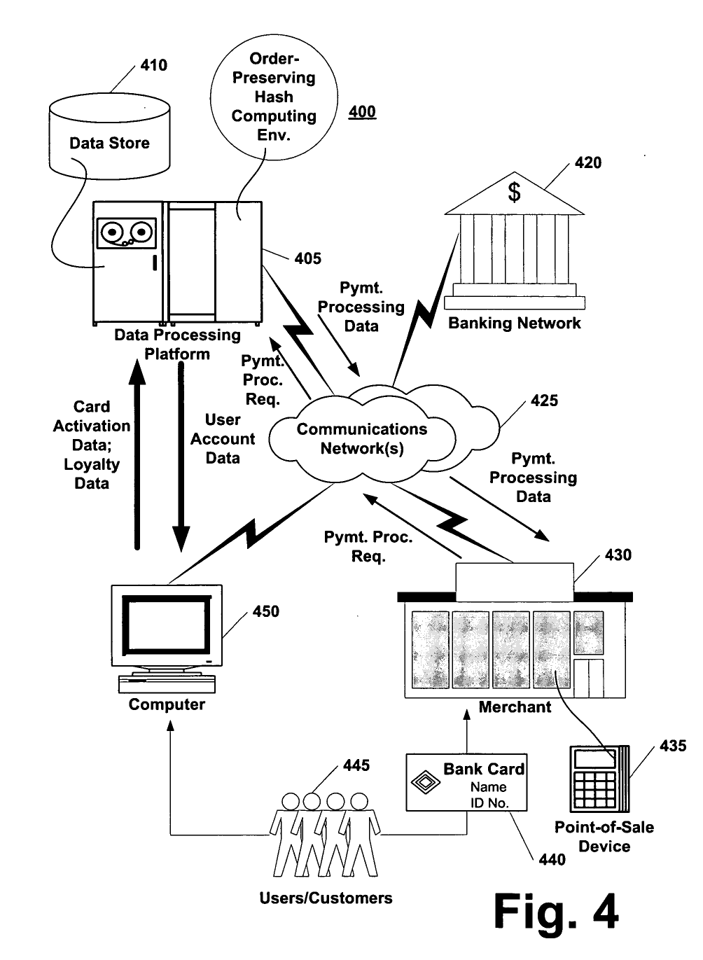

FIG. 4 shows the interaction of cooperating parties of an exemplary data processing environment 400 that can be a part of a transaction payment environment (not shown). As is shown, in an illustrative implementation, data processing environment 500 comprises data processing platform 405 (operating an order-preserving hash computing environment 407) that cooperates with data store 410, banking network 420, communications network(s) 425, merchant, 430, point-of-sale device 435, transaction card, 440, user/customers 445, and computer 450.

In an illustrative operation, a customer 445 may use a transaction card 440 to purchase goods and/or services from a merchant 430. In this context, user 445 provides the merchant 430 with the transaction card 440 having an associated value (not shown). The merchant 430 processes the purchase by swiping the card (or entering in via the card identification information) at a point-of-sale device 435. The point-of-sale device 435, being in operable communication with the transaction payment platform 405 through communications network(s) 425 and through banking network 420, communicates a transaction payment processing request to data processing platform 405. Data processing platform 405 processes the transaction payment processing request and provides the data processing results back to POS device 435 over communications network(s) 425. Part in parcel of data processing, data processing platform 405 updates the cardholder's account and sponsor's account in data store 410 to reflect the transaction and communicates with the banking network (e.g. VISA®, MASTERCARD®, etc) 420 transaction data which may be used by the banking network 420 to reconcile possible merchant bank accounts (and/or sponsor bank accounts) to reflect the transaction. When updating the data store, data processing platform 405 can operate to encode the data according to a selected order-preserving hash scheme that is realized by an order-preserving hash computing environment 407 resident on the data processing platform.

Also, as is shown, customers 445 can interact with data processing platform 405 through computer 450 that is in operable communication with data processing platform 405 through communication network(s) 425. Included in such customer interaction with data processing platform 405 can be card activation activities and account management activities.

In the context of card activation (e.g., pre-paid debit card activation, healthcare spending account card activation, gift card activation, etc.), in an illustrative implementation, data processing platform 405 can operate to establish accounts for card holders and, upon the card holder receiving a the card, operating to receive card activation information a cooperating device such as computer 450. The transaction payment processing platform 405, as is described in more detail below, can operate a number of applications including online shop and earn. When creating accounts data processing platform 405 can operate to encode the account data for storage (and subsequent retrieval) in data store 410 that can cooperate with data processing platform. The account data can be encoded by employing an order-preserving hash computing application (not shown) that can reside in computing application environment 407 resident on the data processing platform 405.

It is appreciated that although an illustrative data processing environment 405 is described to have various components cooperating in various configurations that such description is merely exemplary as the inventive concepts described herein can be applied to a number of data processing environments having different components cooperating in different configurations.

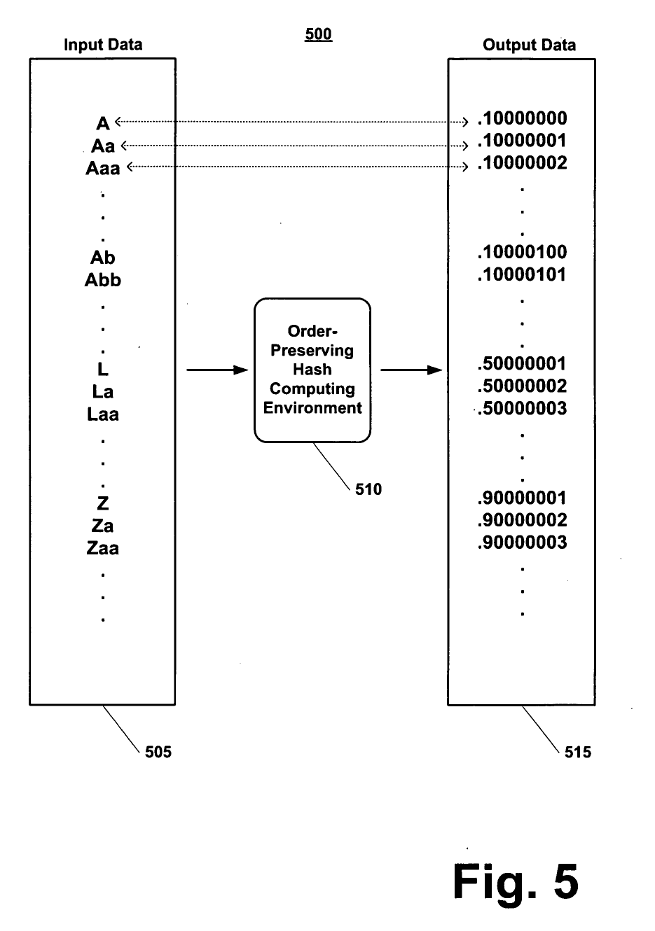

FIG. 5 is a block diagram showing exemplary data environment 500 having input data 505, order-preserving hash computing environment 510, and output data 515. In an illustrative operation, data environment 500 can provide selected input data 505 which in the illustrative implementation comprises a list of possible letter combinations. The input data can be processed by order-preserving hash computing environment 510 to generate output data 515. In the illustrative implementation, a fractional decimal representation can be generated at the output data 515 for each element of the input data 505. In the illustrative implementation, the letter “A” can be encoded by the order-preserving has computing environment 510 to generate a decimal fraction representation 0.10000000 (as indicated by the dashed arrow). The output data coupled with the input data and selected parameters on the data environment 500 can comprise an encoding scheme and model. In an illustrative implementation, data environment 500 and its components can describe an exemplary arithmetic coding model for use in encoding input data. In this illustrative implementation, the selected parameters on the data environment can comprise interval and sub-interval lengths.

It is appreciated that although exemplary data environment 500 is shown to have particular input data, output data, and an order-preserving hash computing environment that such description is merely illustrative as the inventive concepts described herein can extend to various data environments having various configurations.

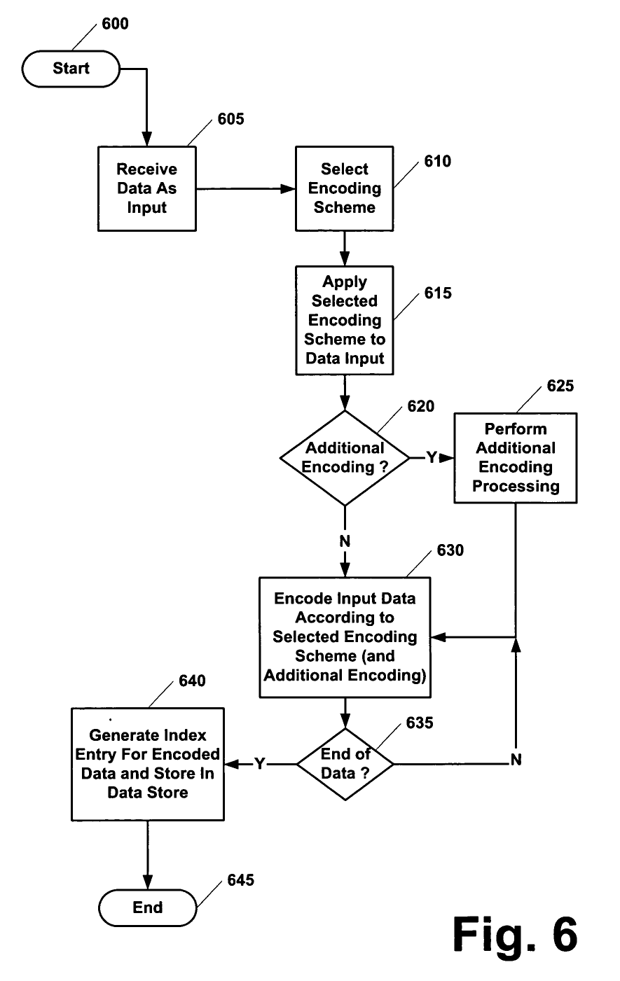

FIG. 6 shows the processing performed when encoding data for storage (and subsequent retrieval) in a cooperating data store. As is shown in FIG. 6, processing begins at block 600 and proceeds to block 605 where data is received as input. Processing then proceeds to block 610 where an encoding scheme is selected (e.g., arithmetic encoding). From there, processing proceeds to block 615 where the selected encoding scheme is applied to the data input to encode the data. In this processing block the encoding scheme sets the instructions to process the data. In an illustrative implementation, if arithmetic encoding is selected as the selected encoding scheme, a model would be created, an interval(s) chosen, and the data processed according to the numeric model and intervals.

A check is then performed at block 620 to determine if additional encoding steps are required (e.g., in the case arithmetic coding is the selected encoding scheme—adding more intervals or modifying the model according to renormalization). If the check at block 620 indicates that additional encoding steps are required, processing proceeds to block 625 where the additional encoding processing is performed. From block 625, processing proceeds to block 630 where the input data is encoded according to the selected encoding scheme (and the additional encoding steps if needed). A check is then performed at block 635 to determine if the end of data indicator has been processed. If the check at block 635 indicates that the end of data has not been processed, processing reverts to block 630 and proceeds from there. However, if the check at block 635 indicates that the end of data has been processed, processing proceeds to block 640 where an index entry for the encoded data is generated and stored in a data store (e.g., in the case arithmetic coding is selected as the selected encoding scheme, the index entry is the numeric (decimal and/or binary) representation of the data as encoded according to the encoding scheme). Processing then terminates at block 640.

However, if at block 620 it is determined that there are no additional encoding steps required, processing proceeds to block 630 and proceeds from there.

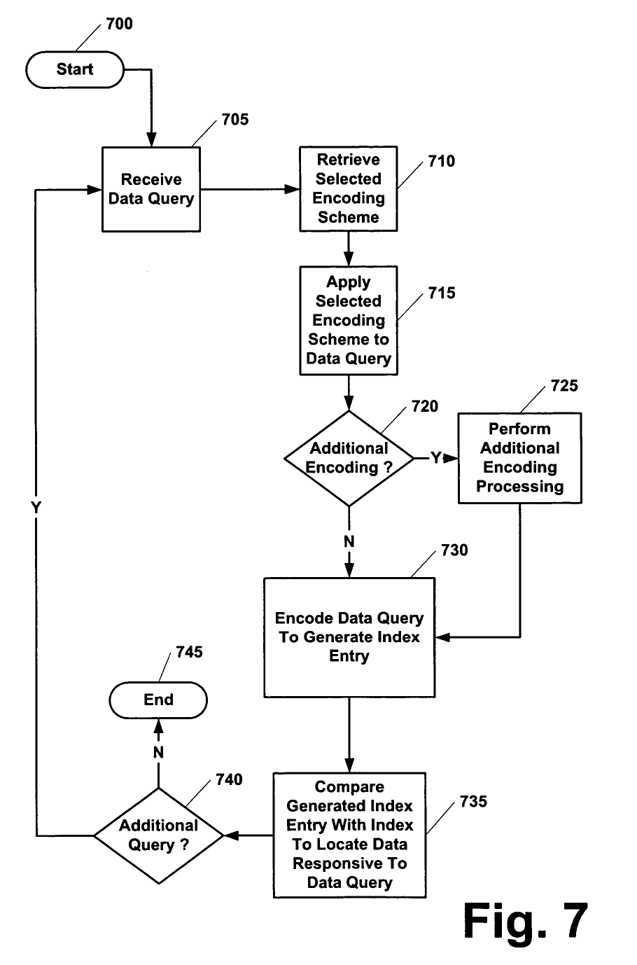

FIG. 7 shows the processing performed when retrieving encoded stored data in a cooperating data store. As is shown in FIG. 7, processing begins at block 700 and proceeds to block 705 where a data query is received to retrieve encoded data from a cooperating data store. From there processing proceeds to block 710 where the selected encoding scheme that was used to encode the data for which a query is being made is retrieved. The retrieved selected encoding scheme is then applied to the data query at block 715. A check is then performed to determine if additional encoding steps (e.g., additional intervals or change in the encoding model) is required. If the check at block 720 indicates that additional encoding steps are required, processing proceeds to block 725 where the additional encoding processing steps are performed.

From there processing proceeds to block 730 where the data query is encoded to generate an index entry (e.g., in arithmetic coding the data query would be encoded to generate a fractional number). The generated index entry is then compared at block 735 with the index found in the data store to locate data that would be responsive to the data query. A check is then performed at block 740 to determine if there are any additional queries. If the check at block 740 indicates that there are additional queries, processing reverts back to block 705 and proceeds from there. However, if the check at block 740 indicates that there are no additional queries, processing terminates at block 745.

However, if at block 720 it is determined that there are no additional encoding steps required, processing proceeds to block 730 and proceeds from there.

In sum, the herein described apparatus and methods provide a data communication architecture employing for use as a computing environments communication fabric that reduces data latency. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A method for encoding data according to an order-preserving hash operation comprising:
receiving input data that is ordered according to one or more elements in the input data;
providing an order-preserving hash operation to generate an encoded representation of the input data; and
executing the order-preserving hash operation on queries for the input data to satisfy the queries.

2. The method as recited in claim 1 further comprising storing the encoded representation of the input data in a cooperating data store.

3. The method as recited in claim 2 further comprising retrieving encoded representations of the input data from the cooperating data store to satisfy the queries.

4. The method as recited in claim 3 further comprising associating the encoded representations of the input data to a data record found in the data store.

5. The method as recited in claim 4 further comprising generating an index of the encoded representations of the input data stored in the cooperating data store.

6. The method as recited in claim 5 further comprising comparing the results of the order-preserving hash operation performed on the queries for the input data against the generated index to locate the input data in the cooperating data store.

7. The method as recited in claim 6 further comprising providing an arithmetic coding scheme as a basis for the order-preserving hash operation.

8. The method as recited in claim 7 further comprising using a binary representation of the fractions produced by the arithmetic coding scheme when performing the order-preserving has operation.

9. The method as recited in claim 8 further comprising providing the order-preserving hash operation as part of a transaction payment system.

10. A computer-readable medium having computer readable instructions to provide instructions to a computer to perform a method comprising:
receiving input data that is ordered according to one or more elements in the input data;
providing an order-preserving hash operation to generate an encoded representation of the input data; and
executing the order-preserving hash operation on queries for the input data to satisfy the queries.

11. A system to encode data according to an order preserving hash operation comprising:
a computing environment;
an order-preserving hash computing application operable on the computing environment to process input data and to generate an encoded representation of the input data that is stored in a cooperating data store,
wherein the order-preserving hash computing application is operable on data queries for the input data to generate an encoded representation of the data queries for use in identifying the input data.

12. The system as recited in claim 11 further comprising a data index generated by the order-preserving hash computing application that is stored in the data store.

13. The system as recited in claim 12 wherein the data index can be used to locate input data when compared to the results of the order-preserving hash operation on data queries.

14. The system as recited in claim 13 further comprising a networked computing environment.

15. The system as recited in claim 14 further comprising an order-preserving has computing application that uses one or more arithmetic coding schemes when processing input data to generate the encoded representations of the input data.

16. A method to perform order-preserving encoding comprising:
receiving ordered input data that is ordered according to one or more elements of the input data;
establishing a data model according to a selected arithmetic coding scheme;
storing the data model in a order-preserving computing application;
processing the received ordered input data using the order-preserving computing application according to the data model to generate encoded output data,
wherein the order-preserving computing application is also used to process data queries for received input data from cooperating parties;
storing the encoded output data in a cooperating data store;

17. The method as recited in claim 16 further comprising establishing one or more intervals for use in the data model.

18. The method as recited in claim 17 further comprising providing fractional representations as encoded output data,
wherein the fractional representations are consistent with the arithmetic coding data model.

19. The method as recited in claim 18 further comprising processing one or more queries for input data using the order-preserving computing application to generate an encoded representation of the one or more queries.

20. The method as recited in claim 19 further comprising comparing the results of the encoded representation of the one or more queries with the encoded output data stored in the cooperating data store.
